(19) United States
(12) Patent Application Publication
(10) Pub. No.: US 2021/0033283 A1
(43) Pub. Date: Feb. 4, 2021

(54) DIFFUSER CASE HEATSHIELDS FOR GAS TURBINE ENGINES

(71) Applicant: United Technologies Corporation, Farmington, CT (US)

(72) Inventors: Donna J. Chavez, Glastonbury, CT (US); Lisa P. O'Neill, Manchester, CT (US)

(21) Appl. No.: 16/526,427

(22) Filed: Jul. 30, 2019

(51) Int. Cl. F23R 3/00; F23R 3/02

(52) U.S. Cl. CPC F23R 3/005; F23R 2900/03043; F23R 3/02; F23R 3/002

(57) ABSTRACT

Heatshields for installation within gas turbine engines are described. The heatshields include a metal body having a first end, a second end, a first side, and a second side, wherein the first side and the second side define parallel sides extending from the first end to the second end, an engagement portion formed along the first side and arranged to engage with a portion of a case, a shielding portion formed along the second side, and a mid-body portion extending between the engagement portion and the shielding portion and has an arcuate shape in cross-section. The metal body is configured to form a hoop, split-ring structure with the first end attached to the second end.

### BACKGROUND

Illustrative embodiments pertain to the art of turbomachinery, and specifically to struts of gas turbine engines.

Gas turbine engines are rotary-type combustion turbine engines built around a power core made up of a compressor, combustor and turbine, arranged in flow series with an upstream inlet and downstream exhaust. The compressor compresses air from the inlet, which is mixed with fuel in the combustor and ignited to generate hot combustion gas. The turbine extracts energy from the expanding combustion gas, and drives the compressor via a common shaft. Energy is delivered in the form of rotational energy in the shaft, reactive thrust from the exhaust, or both.

The individual compressor and turbine sections in each spool are subdivided into a number of stages, which are formed of alternating rows of rotor blade and stator vane airfoils. The airfoils are shaped to turn, accelerate and compress the working fluid flow, or to generate lift for conversion to rotational energy in the turbine.

The combustor section includes a combustor where combustion takes place. In a gas turbine engine, the combustor is fed high pressure air by the compressor section. The combustor then heats this air at constant pressure. After heating, air passes from the combustor section through the turbine section (vanes and rotating blades). A combustor must contain and maintain stable combustion despite very high air flow rates. To do so combustors are carefully designed to first mix and ignite the air and fuel, and then mix in more air to complete the combustion process. Combustors play a crucial role in determining many operating characteristics of a gas turbine engine, such as fuel efficiency, levels of emissions, and transient response (i.e., the response to changing conditions such as fuel flow and air speed).

A combustor of the combustor section is typically coupled to an engine case of the gas turbine engine. The engine case may include a diffuser case, which circumscribes the compressor section. The diffuser case and associated fittings may be subjected to relatively high temperatures due to heat convectively transferred from the combustor to the diffuser case. Thermal loads in the diffuser case may cause thermal gradients that may stress, deform, fracture, and/or degrade portions of the diffuser case over time. A flange of the diffuser case may experience thermal gradients of at least 400° F. (204° C.) to 600° F. (315° C.). Stress and degradation caused by the thermal gradients may shorten the operational life of engine case components. During operation, the thermal load on an engine case may increase the overall length of the engine case. This thermal growth may contribute to misalignment of engine components and liberation of components. Component liberation may contribute to loss of performance and/or efficiency of the gas turbine engine and/or degradation of components within the gas turbine.

### BRIEF DESCRIPTION

According to some embodiments, heatshields for installation within gas turbine engines are provided. The heatshields include a metal body having a first end, a second end, a first side, and a second side, wherein the first side and the second side define parallel sides extending from the first end to the second end, an engagement portion formed along the first side and arranged to engage with a portion of a case, a shielding portion formed along the second side, and a mid-body portion extending between the engagement portion and the shielding portion and has an arcuate shape in cross-section. The metal body is configured to form a hoop, split-ring structure with the first end attached to the second end.

In addition to one or more of the features described above further embodiments of the heatshields may include that the metal body is formed from one of sheet metal and a nickel alloy.

In addition to one or more of the features described above further embodiments of the heatshields may include that the first end comprises at least one first locking element and the second end comprises at least one second locking element configured to securely engage with the at least one first locking element.

In addition to one or more of the features described above further embodiments of the heatshields may include that the at least one first locking element comprises a tab and the at least one second locking element comprises a slot configured to receive the tab.

In addition to one or more of the features described above further embodiments of the heatshields may include that the at least one first locking element comprises a dimple at the first end and the at least one second locking element comprises an indent in the metal body at the second end configured to receive the dimple.

In addition to one or more of the features described above further embodiments of the heatshields may include that a portion of the first end overlaps with the second end when formed as the hoop, split-ring structure.

In addition to one or more of the features described above further embodiments of the heatshields may include that the metal body has a thickness of between about 0.020 inches and about 0.040 inches.

According to some embodiments, gas turbine engines are provided. The gas turbine engines include a combustor section having a diffuser case with a diffuser case flange, a turbine section arranged aft of the combustor section along an engine central longitudinal axis, the turbine section having turbine case with a turbine case flange, a connection wherein the diffuser case flange is connected to the turbine case flange, and a heatshield installed to the diffuser case. The heatshield includes a metal body having a first end, a second end, a first side, and a second side, wherein the first side and the second side define parallel sides extending from the first end to the second end, an engagement portion formed along the first side and arranged to engage with a portion of the diffuser case, a shielding portion formed along the second side and positioned radially inward from the connection, and a mid-body portion extending between the engagement portion and the shielding portion having an arcuate shape in cross-section. The metal body is configured to form a hoop, split-ring structure with the first end attached to the second end.

In addition to one or more of the features described above further embodiments of the gas turbine engines may include that the metal body is formed from one of sheet metal and a nickel alloy.

In addition to one or more of the features described above further embodiments of the gas turbine engines may include that the first end comprises at least one first locking element and the second end comprises at least one second locking element configured to securely engage with the at least one first locking element.

In addition to one or more of the features described above further embodiments of the gas turbine engines may include that the at least one first locking element comprises a tab and the at least one second locking element comprises a slot configured to receive the tab.

In addition to one or more of the features described above further embodiments of the gas turbine engines may include that the at least one first locking element comprises a dimple at the first end and the at least one second locking element comprises an indent in the metal body at the second end configured to receive the tab.

In addition to one or more of the features described above further embodiments of the gas turbine engines may include that a portion of the first end overlaps with the second end when formed as the hoop, split-ring structure.

In addition to one or more of the features described above further embodiments of the gas turbine engines may include that the metal body has a thickness of between about 0.020 inches and about 0.040 inches.

In addition to one or more of the features described above further embodiments of the gas turbine engines may include that the diffuser case include a case support configured to receive the engagement portion of the heatshield.

In addition to one or more of the features described above further embodiments of the gas turbine engines may include that an air gap is formed between the heatshield and the connection.

In addition to one or more of the features described above further embodiments of the gas turbine engines may include that the mid-body portion of the heatshield contacts the diffuser case at a contact region.

In addition to one or more of the features described above further embodiments of the gas turbine engines may include a vane support having a vane support flange, wherein the vane support flange is engaged between the diffuser case flange and the turbine case flange at the connection.

In addition to one or more of the features described above further embodiments of the gas turbine engines may include a fastener at the connection to join the diffuser case flange to the turbine case flange.

In addition to one or more of the features described above further embodiments of the gas turbine engines may include a case extension attached to the diffuser case, wherein the diffuser case flange is part of the case extension.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be illustrative and explanatory in nature and non-limiting.

### BRIEF DESCRIPTION OF THE DRAWINGS

The following descriptions should not be considered limiting in any way. With reference to the accompanying drawings, like elements are numbered alike: The subject matter is particularly pointed out and distinctly claimed at the conclusion of the specification. The foregoing and other features, and advantages of the present disclosure are apparent from the following detailed description taken in conjunction with the accompanying drawings in which like elements may be numbered alike and:

FIG. 1 is a schematic cross-sectional illustration of a gas turbine engine that can incorporate embodiments of the present disclosure;

FIG. 2 is a schematic illustration of a flange section of a gas turbine engine;

FIG. 3 is a schematic illustration of a flange section of a gas turbine engine in accordance with an embodiment of the present disclosure;

FIG. 4A is a plan view illustration of a heatshield in accordance with an embodiment of the present disclosure;

FIG. 4B is a schematic illustration of ends of the heatshield shown in FIG. 4A;

FIG. 4C is a schematic illustration of the ends of the heatshield shown in FIG. 4B as joined together;

FIG. 4D is an isometric illustration of the heatshield of FIG. 4A as assembled into a hoop, split-ring structure;

FIG. 4E is another plan view illustration of the heatshield of FIG. 4A; and

FIG. 5 is a schematic illustration of a flange section of a gas turbine engine in accordance with an embodiment of the present disclosure.

### DETAILED DESCRIPTION

Detailed descriptions of one or more embodiments of the disclosed apparatus and/or methods are presented herein by way of exemplification and not limitation with reference to the Figures.

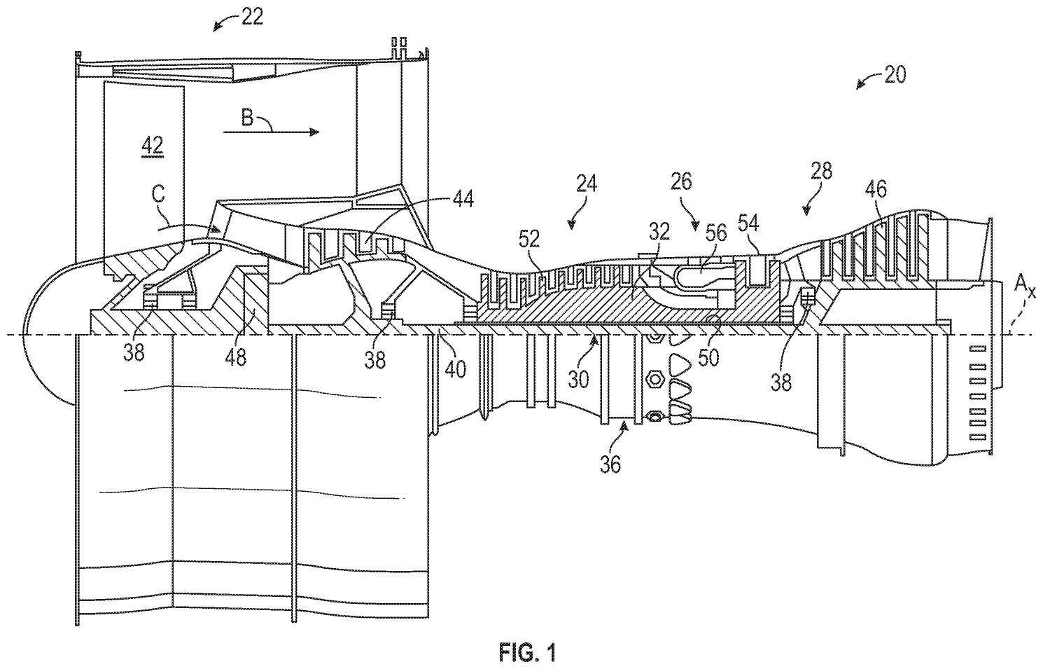

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines.

The exemplary engine 20 generally includes a low speed spool 30 and a high speed spool 32 mounted for rotation about an engine central longitudinal axis Aₓ relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 can be connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing systems 38 in the turbine section 28. The inner shaft 40 and the outer shaft 50 are concentric and rotate via bearing systems 38 about the engine central longitudinal axis Aₓ which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present disclosure is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,688 meters). The flight condition of 0.8 Mach and 35,000 ft (10,688 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(514.7° R)]^{0.5}. The “Low corrected fan tip speed” as disclosed herein according to one non-limiting embodiment is less than about 1150 ft/second (350.5 m/sec).

Although the gas turbine engine 20 is depicted as a turbofan, it should be understood that the concepts described herein are not limited to use with the described configuration, as the teachings may be applied to other types of engines such as, but not limited to, turbojets, turboshafts, and turbofans wherein an intermediate spool includes an intermediate pressure compressor (“IPC”) between a low pressure compressor (“LPC”) and a high pressure compressor (“HPC”), and an intermediate pressure turbine (“IPT”) between the high pressure turbine (“HPT”) and the low pressure turbine (“LPT”).

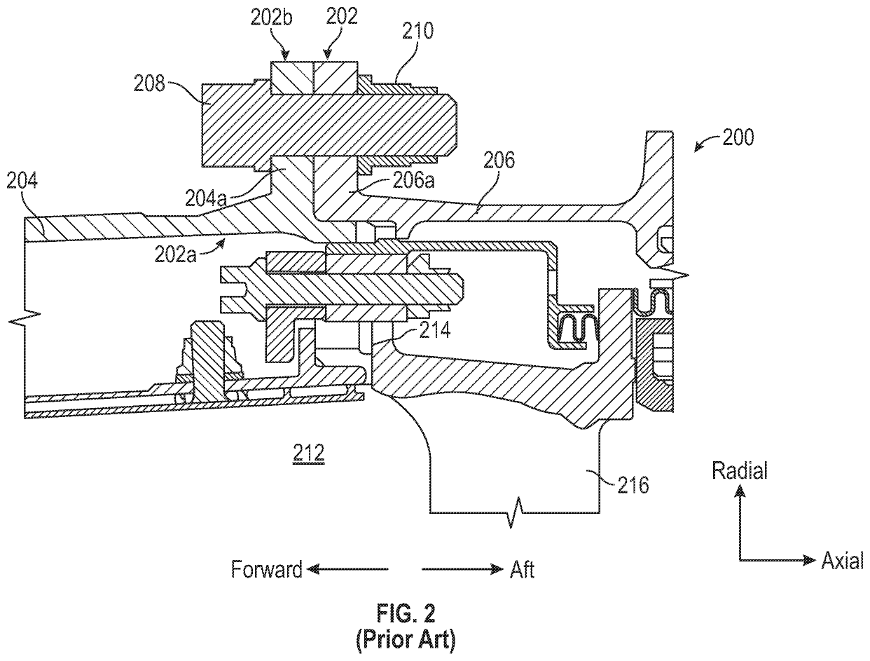

There are frequently several flanges located at or near the exterior of the engine that separate the various sections of the engine. For example, referring to FIG. 2, a schematic illustration of a flange section 200 of a gas turbine engine is shown. As shown, a connection 202 serves to connect a diffuser case 204 and a turbine case 206 (e.g., high pressure turbine). The connection 202 includes a diffuser case flange 204a and a turbine case flange 206a, with each flange 204a, 206a having one or more holes or apertures to receive one or more fasteners (e.g., a bolt 208 and a nut 210) to couple the diffuser case 204 to the HPT case 206.

The portion of the engine in proximity to the connection 202 is typically one of the hottest, as the portion is located radially outboard of a combustion chamber 212 (e.g., of a combustor section). The connection 202 features two distinct areas where the radial interference of two parts form an interference fit; this occurs at the fully circumferential landing between the diffuser case 204 and the turbine 206. The radially inner surface of this landing also provides a mating face to a first stage HPT turbine vane support 214 of a first stage HPT vane 216.

The arrangement of the flange section 200 results in a radially inner portion 202a of the connection 202 being at a much higher temperature than a radially outer portion 202b of the connection 202 where the holes/apertures are that receive the fastener (i.e., the bolt 208 and the nut 210). In some configurations and operating conditions, a temperature gradient between the radially inner portion 202a and the radially outer portion 202b may vary as much as, for example, 400° Fahrenheit depending on the power settings of the engine. This temperature gradient results in thermally driven stress at the connection 202, which may result in a low lifetime (frequently referred to in the art as a low cycle fatigue (LCF)) limit in the diffuser case 204.

Although the connection 202, in FIG. 2, is shown as directly joining the diffuser case 204 to the turbine case 206, various other configurations are possible without departing from the scope of the present disclosure. For example, in some engine configurations, a vane support (e.g., the support 214 may also be joined and connected by the one or more fasteners (e.g., the bolt 208 and the nut 210).

Embodiments described herein are directed to a heatshield that may be installed to provide thermal protection or thermal shielding to a flange section of a gas turbine engine. For example, in some embodiments, a heatshield may be installed inboard (e.g., radially inward) from an inner surface or inner portion of a flange that joins a diffuser case and a turbine case. Accordingly, the heatshield can protect the flange from excessive temperatures, and thus prevent material or part degradation, fatigue, and/or failure. In some embodiments, an installation process in accordance with the present disclosure may provide for removing a portion of a case and installing a case extension configured to enable engagement of the heatshield to the case.

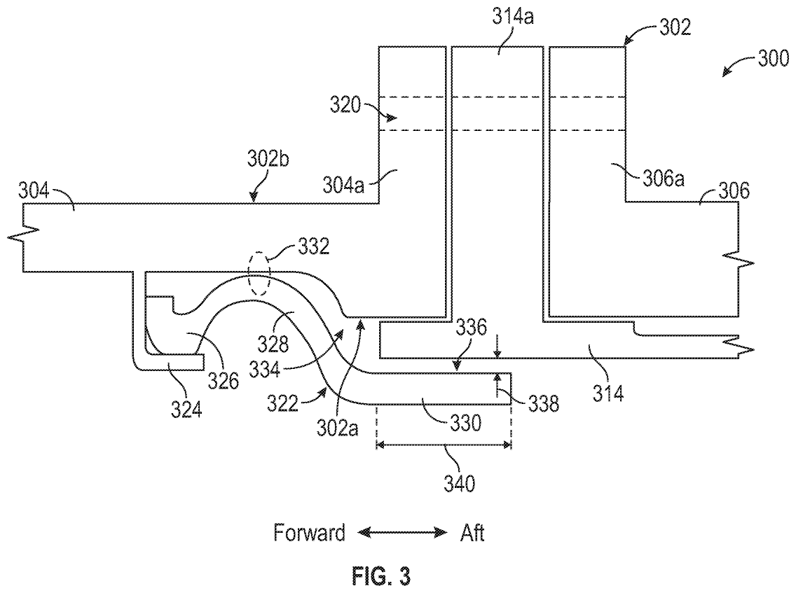

Turning now to FIG. 3, a schematic illustration of a flange section 300 of a gas turbine engine is shown. As shown, a connection 302 of the flange section 300 serves to connect a diffuser case 304 and a turbine case 306 (e.g., high pressure turbine). A diffuser case flange 304a and a turbine case flange 306a are joined together to form a portion of a case of a gas turbine engine. The connection 302 includes one or more holes or apertures 320 to receive one or more fasteners (e.g., a bolt and a nut) to couple the diffuser case 304 to the HPT case 306. In this embodiment, a vane support 314 is arranged with a vane support flange 314a and is also engaged and part of the connection 302. The connection 302 has a radially inner portion 302a and a radially outer portion 302b, with the radially inner portion 302a at least partially thermally protected or shielded by a heatshield 322.

The heatshield 322, in accordance with embodiment of the present disclosure, is a split-ring component. The diameter of the heatshield 322, prior to installation, is greater than a diameter of the diffuser case 304 to allow for a locking feature or engagement with the diffuser case 304. Such difference in diameter may enable an interference or spring fit into engage with the radially inner portion 302a of the connection 302 at the diffuser case 304. In some non-limiting embodiments, the heatshield 322 may be formed from sheet metal, and may be, for example, between about 0.020 inches and about 0.040 inches, although other thicknesses may be employed without departing from the scope of the present disclosure. In some embodiments, the heatshields of the present disclosure may be formed from nickel alloys that are selected for operation at desired temperatures (e.g., at or above 400° F.).

The heatshield 322 is configured to engage with and be supported by a portion of the diffuser case 304. For example, as shown, a case support 324 may extend radially inward from the diffuser case 304 to provide a forward end engagement or land for receiving the heatshield 322. The case support 324 may be integrally formed with or from the diffuser case 304 or may be attached to the diffuser case 304 (e.g., by welding, fasteners, high temperature adhesives, bonding, etc.). The case support 324 may extend in an axial direction (e.g., from forward to aft) for a length or depth of about 0.050 inches to about 0.100 inches.

The heatshield 322 is defined by a metal body having an engagement portion 326 (e.g., at a forward end when installed), a mid-body portion 328, and a shielding portion 330 (e.g., at an aft end when installed). The engagement portion 326 is configured to securely engage with the case support 324 of the diffuser case 304. The mid-body portion 328 is configured to contact the radially inner portion 302a of the connection 302, and specifically with a radially inward facing surface of the diffuser case 304 at a contact region 332. In some embodiments, the contact region 332 may be minimized in surface area to minimize the amount of material contact between the mid-body portion 328 and the diffuser case 304. The mid-body portion 328 is bent, curved, or arcuate in shape, in cross-section, and as shown in FIG. 3. As such, thermal conduction from the heatshield 322 to the diffuser case 304 through direct contact may be minimized.

The mid-body portion 328 and the shielding portion 330 are arranged to form an air gap 334 between the heatshield 322 and the flange 302, thus enabling a thermally insulating or low heat conductive air pocket to reduce thermal temperatures in contact with the flange 302. The air gap 334 may include, as shown, an aft extension 336 of the air gap 334 between the shielding portion 330 and, in this embodiment, a portion of the vane support 314. However, in other embodiments, any portion of the flange 302 may be protected by such aft extension 336 of the air gap 334. To enable the aft extension of the air gap 334, a first separation gap 338 is maintained between the shielding portion 330 and the flange 302. The shielding portion 330 may extend an extension length 340 from the mid-body portion 328 in a direction away from the engagement portion 326. The extension length 340 of the shielding portion 330 may be selected to provide a desired amount of overlap and/or thermal shielding and aft extension 336 of the air gap 334 when installed within a gas turbine engine.

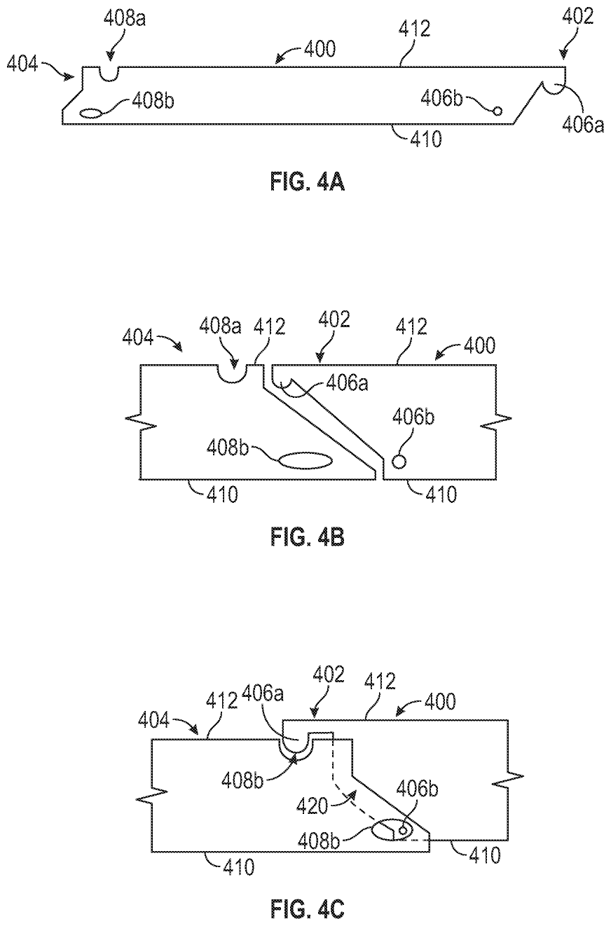

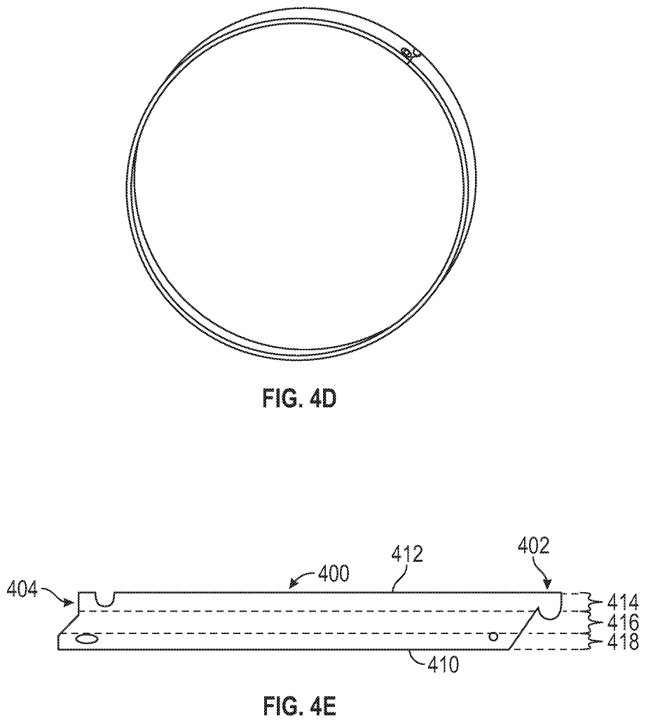

As noted, the heatshield of the present disclosure may be formed from sheet metal and may have a split-ring configuration. For example, as shown in FIGS. 4A-4E, schematic illustrations of a heatshield 400 are shown. FIG. 4A illustrates the heatshield 400 in a flat or plan view, prior to forming a ring structure. FIG. 4B illustrations two ends of the heatshield 400 prior to joining thereof. FIG. 4C illustrations the ends of the heatshield 400 as joined. FIG. 4D is an isometric illustration of the heatshield 400 formed into a split-ring hoop structure for installation within a gas turbine engine. FIG. 4E is another flat or plan view of the heatshield 400 illustrating portions thereof.

The heatshield 400, as shown, is a sheet metal component having a first end 402 and a second end 404. The first end 402 includes one or more first locking elements 406a, 406b and the second end 404 includes one or more respective second locking elements 408a, 408b. The first locking elements 406a, 406b are arranged and configured to engage and provide secured connection with the respective second locking elements 408a, 408b such that the first end 402 may be joined to the second end 404 to form a split-ring structure, as shown in FIG. 4D.

As shown, one of the first locking elements 406a is a tab, protrusion, or hook-type element that may be received by a respective second locking 408a. The second locking element 408a for this locking configuration is a recess cut-out that is configured to receive the first locking element 406a. The other first locking element 406b of this embodiment may be a dimple, bump, protrusion, or extension of material that projects outward from the material of the heatshield 400 and may be received in an indent or slot. This first locking element 406b may be received within a recess or hole that forms a respective second locking element 408b. In some embodiments, such as shown in FIGS. 4A-4C, the pairs of locking elements 406a, 408a, 406b, 408b may be arranged at opposing forward/aft sides of the heatshield 400. Or, as shown, a first locking element 406a and a respective second locking element 408a may be arranged on a first side 410 and another first locking element 406b and a respective second locking element 408b may be arranged on a second side 412. The first side 410 and the second side 412 define substantially parallel sides of the heatshield 400 and extend between the first end 402 and the second end 404, and define the edges of the heatshield 400.

As shown in FIG. 4E, the first side 410 may be used to form an engagement portion 414. As such, a portion of the heatshield 400 may be crimped or bent to form an engagement structure, such as shown in FIG. 3. A mid-body portion 416 may extend from the engagement portion 414 toward the second side 412. At the second side 412, the heatshield 400 includes a shielding portion 418 which may be angled relative to the mid-body portion 416, such as shown in FIG. 3. In some configurations, and particularly when installed within a gas turbine engine, the first side 410 may be arranged at a forward end or position and the second side 412 may be arranged at an aft end or position. In other embodiments, the reverse may be true, such that the first side is the aft end when installed within a gas turbine engine, and the second side 412 is the forward end.

Referring again to FIG. 4C, when wrapped to form the hoop split-ring structure, a portion of the first end 402 may overlap with a portion of the second end 404. The overlapping region 420 allows for or is provided to enable the locking elements to engage and secure the first end 402 to the second end 404. The overlapping region 420 may also cause an amount of outward force such that when installed within a gas turbine engine, the heatshield 400 will securely engage with a case of the gas turbine engine.

Although shown with two types of locking features, such configurations are merely illustrative and are not to be limiting. For example, in some embodiments, a single pair or set of locking elements may be employed, and in other embodiments, more than two types or two separate locking element sets may be employed. Further, the geometry, shape, size, location, and arrangement of locking elements may be changed without departing from the scope of the present disclosure. For example, rounded, squared, triangular extensions, tabs, or protrusions may be employed with respective features to receive such geometries. Further, bump-groove, slot-groove, bump-indent, key-type, and/or other types of engagement and locking features may be employed without departing from the scope of the present disclosure.

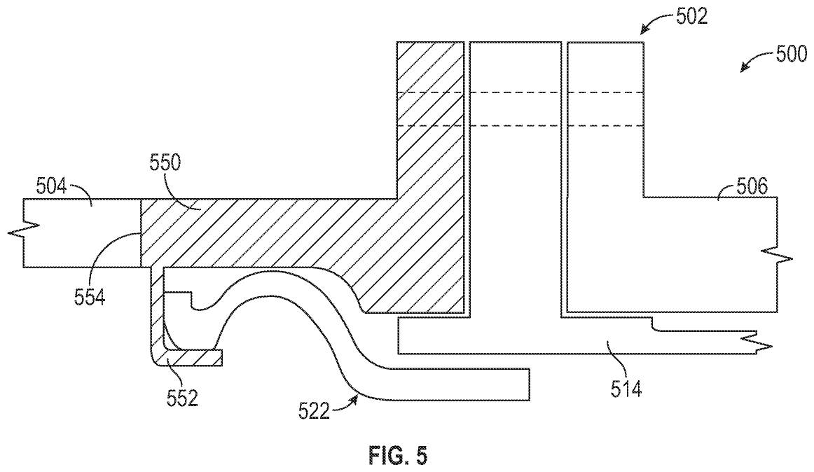

Turning now to FIG. 5, a schematic illustration of a flange section 500 of a gas turbine engine is shown. As shown, a connection 502 of the flange section 500 serves to connect a diffuser case 504 and a turbine case 506, with a vane support 514 arranged therebetween. However, in contrast, to the above embodiments, such as shown in FIG. 3, the configuration of FIG. 5 illustrates a repaired modified case configuration. In this embodiment, the cases 504, 506 may be of an existing and/or in-use gas turbine engine that required repair. In such configuration, the diffuser case 504 may not include a case support (e.g., case support 324 shown in FIG. 3). However, it may be advantageous to install a heatshield of the present disclosure on such case of a gas turbine engine.

As shown, a case extension 550 may be attached to an existing diffuser case 504. For example, during maintenance of a gas turbine engine, the cases may be separated. A portion of the diffuser case may be removed and the case extension 550 may be attached thereto (e.g., by welding, fasteners, high temperature adhesives, bonding, etc.). The case extension 550 includes a case support 552 integrally formed therewith or attached thereto, as described above. The case support 552, in this embodiment, is welded to the diffuser case 504 at a weld joint 554. Once attached, and the gas turbine engine is reassembled, a heatshield 522 may be installed and engaged with the case support 552.

Accordingly, during a repair process a new diffuser case flange (having a case support) may be installed. Subsequently, a sheet metal split ring with an angled overlapping locking feature can be rolled into a ring diameter slightly larger than the inner diffuser case diameter (i.e., the heatshield described herein). The installation of the heatshield ring is from the aft end of the diffuser prior to the first vane pack assembly installation. In this process, an installer can force the ends of the split-ring inward, overlapping the ends to reduce the diameter of the heatshield to slip into the aft end of the diffuser case inner diameter groove at the weld joint (i.e., at the case support). The installer would then release the force allowing the heatshield to spring into place just aft of the flange replacement joint in the inner diameter groove. The locking feature would then be engaged and a small dimple or two would be crimped into the inner aft and forward overlapping areas on the inward bent areas. The dimple crimping ensures the heatshield does not become loose.

The forward end and the aft end of the heatshield will include a rounded bend (e.g., mid-body portion) that restricts the contact with the diffuser case just axially aft of the flange replacement welded joint groove. Further, a shielding portion may extend axially aft of the joining of the turbine case and first vane support fit location by approximately 0.010 inches to about 0.100 inches.

The rolled bump structure of the mid-body portion allows for a small air cavity between the heatshield and the diffuser case flange. The heatshield may include rolled forward and aft end edges. The aft end edges may be rolled to dampen any potential airflow excitation of the edge, thus eliminating potential vibrations. In some embodiment, the rolled edge radii are approximately 0.050-0.300 inches in radius. Further, in some embodiments, replacement flange (e.g., case extension 550 shown in FIG. 5) having the case support thereon may have a tapered inner surface to reduce disrupted airflow.

Advantageously, embodiments of the present disclosure are directed to heat shields and cases for gas turbine engines that have reduced thermal stresses at flanges or connections between difference case components. Advantageously, embodiments provided herein can be formed as part of new cases or may be retro-fit to old cases, with the features described herein installed during a maintenance operation. The heatshields of the present disclosure provide for improved thermal protection while enabling relatively easy installation and inspection by having a single part that is spring-fit into the case and provides thermal protection thereto.

As used herein, the term “about” is intended to include the degree of error associated with measurement of the particular quantity based upon the equipment available at the time of filing the application. For example, “about” may include a range of ±8%, or 5%, or 2% of a given value or other percentage change as will be appreciated by those of skill in the art for the particular measurement and/or dimensions referred to herein.

The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof. It should be appreciated that relative positional terms such as “forward,” “aft,” “upper,” “lower,” “above,” “below,” “radial,” “axial,” “circumferential,” and the like are with reference to normal operational attitude and should not be considered otherwise limiting.

While the present disclosure has been described with reference to an illustrative embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A heatshield for installation within a gas turbine engine, the heatshield comprising:
a metal body having a first end, a second end, a first side, and a second side, wherein the first side and the second side define parallel sides extending from the first end to the second end;
an engagement portion formed along the first side and arranged to engage with a portion of a case;
a shielding portion formed along the second side; and
a mid-body portion extending between the engagement portion and the shielding portion and has an arcuate shape in cross-section,
wherein the metal body is configured to form a hoop, split-ring structure with the first end attached to the second end.

2. The heatshield of claim 1, wherein the metal body is formed from one of sheet metal and a nickel alloy.

3. The heatshield of claim 1, wherein the first end comprises at least one first locking element and the second end comprises at least one second locking element configured to securely engage with the at least one first locking element.

4. The heatshield of claim 3, wherein the at least one first locking element comprises a tab and the at least one second locking element comprises a slot configured to receive the tab.

5. The heatshield of claim 3, wherein the at least one first locking element comprises a dimple at the first end and the at least one second locking element comprises an indent in the metal body at the second end configured to receive the dimple.

6. The heatshield of claim 1, wherein a portion of the first end overlaps with the second end when formed as the hoop, split-ring structure.

7. The heatshield of claim 1, wherein the metal body has a thickness of between about 0.020 inches and about 0.040 inches.

8. A gas turbine engine comprising:
a combustor section having a diffuser case with a diffuser case flange;
a turbine section arranged aft of the combustor section along an engine central longitudinal axis, the turbine section having turbine case with a turbine case flange;
a connection wherein the diffuser case flange is connected to the turbine case flange; and
a heatshield installed to the diffuser case, the heatshield comprising:
a metal body having a first end, a second end, a first side, and a second side, wherein the first side and the second side define parallel sides extending from the first end to the second end;
an engagement portion formed along the first side and arranged to engage with a portion of the diffuser case;
a shielding portion formed along the second side and positioned radially inward from the connection; and
a mid-body portion extending between the engagement portion and the shielding portion having an arcuate shape in cross-section,
wherein the metal body is configured to form a hoop, split-ring structure with the first end attached to the second end.

9. The gas turbine engine of claim 8, wherein the metal body is formed from one of sheet metal and a nickel alloy.

10. The gas turbine engine of claim 8, wherein the first end comprises at least one first locking element and the second end comprises at least one second locking element configured to securely engage with the at least one first locking element.

11. The gas turbine engine of claim 10, wherein the at least one first locking element comprises a tab and the at least one second locking element comprises a slot configured to receive the tab.

12. The gas turbine engine of claim 10, wherein the at least one first locking element comprises a dimple at the first end and the at least one second locking element comprises an indent in the metal body at the second end configured to receive the tab.

13. The gas turbine engine of claim 8, wherein a portion of the first end overlaps with the second end when formed as the hoop, split-ring structure.

14. The gas turbine engine of claim 8, wherein the metal body has a thickness of between about 0.020 inches and about 0.040 inches.

15. The gas turbine engine of claim 8, wherein the diffuser case include a case support configured to receive the engagement portion of the heatshield.

16. The gas turbine engine of claim 8, wherein an air gap is formed between the heatshield and the connection.

17. The gas turbine engine of claim 8, wherein the mid-body portion of the heatshield contacts the diffuser case at a contact region.

18. The gas turbine engine of claim 8, further comprising a vane support having a vane support flange, wherein the vane support flange is engaged between the diffuser case flange and the turbine case flange at the connection.

19. The gas turbine engine of claim 8, further comprising a fastener at the connection to join the diffuser case flange to the turbine case flange.

20. The gas turbine engine of claim 8, further comprising a case extension attached to the diffuser case, wherein the diffuser case flange is part of the case extension.
